(19) United States
(12) Patent Application Publication
(10) Pub. No.: US 2026/0024270 A1
(43) Pub. Date: Jan. 22, 2026

(54) FAST SHEARED BOX COMPUTATION FOR SCENE GEOMETRY

(71) Applicant: NVIDIA Corporation, Santa Clara, CA (US)

(72) Inventors: Tomas Akenine-Moller, Lund (SE); Cyril Jean-Francois Crassin, Paris (FR)

(21) Appl. No.: 19/208,415

(22) Filed: May 14, 2025

Related U.S. Application Data
(60) Provisional application No. 63/672,852, filed on Jul. 18, 2024.

(51) Int. Cl. G06T 15/10

(52) U.S. Cl. CPC G06T 15/10; G06T 2210/12

(57) ABSTRACT

Ray tracing simulates how light interacts with objects in a scene to render realistic images. In many ray tracing solutions, a bounding volume around a geometry in the scene is computed and a ray intersection with the bounding volume is tested. For a ray that does not intersect the bounding volume, tracing of the ray can be skipped for points within the bounding volume, thereby saving significant processing time and accelerating the ray tracing performed for a given scene. Most current ray-object intersection tests rely on use of axis-aligned bounding boxes, which do not usually fit closely to the actual geometry in the scene. However, using sheared boxes is computationally inefficient and not feasible for use with real-time rendering. The present disclosure provides fast sheared box computations for scene geometry, which can better fit the box to the scene geometry while still being computed efficiently to allow for real-time rendering.

### RELATED APPLICATION(S)

This application claims the benefit of U.S. Provisional Application No. 63/672,852 (Attorney Docket No. NVIDP1410+/24-SV-0860US01), titled “FAST SHEAR BOX COMPUTATION USING EDGE-AND NORMAL-ALIGNING” and filed Jul. 18, 2024, the entire contents of which is incorporated herein by reference.

### TECHNICAL FIELD

The present disclosure relates to computing sheared boxes for ray tracing.

### BACKGROUND

Ray tracing is a computer graphics process that simulates how light interacts with objects in a scene to render realistic images of the scene. In many ray tracing solutions, a bounding volume around a geometry in the scene is computed and a ray intersection with the bounding volume is tested. For a ray that does not intersect the bounding volume, tracing of the ray can be skipped for points within the bounding volume, thereby saving significant processing time and accelerating the ray tracing performed for a given scene.

Currently, axis aligned bounding boxes are primarily relied upon for testing ray intersections. The axis aligned bounding boxes are organized in a hierarchy called a bounding volume hierarchy, which is a tree of nodes, where each node may hold a box. This makes for faster ray tracing. However, since an axis aligned bounding box is a rectangular box in three-dimensional (3D) space with its edges aligned with the coordinate axes (x, y, and z), this type of box usually does not closely fit to the actual geometry in the scene being tested. With some current graphics processing units (GPUs), there is a possibility to use sheared boxes for testing ray intersections, which can better fit to the scene geometry, but there is no efficient way to compute which one of over one thousand possible shear configurations to use for a given geometry. As a result, sheared boxes are generally not feasible for use with real-time rendering.

There is thus a need for addressing these issues and/or other issues associated with the prior art. For example, there is a need to provide fast sheared box computations for scene geometry.

### SUMMARY

A method, computer readable medium, and system are disclosed for computing a sheared box for a geometry. Eigendecomposition is performed for a geometry to obtain a plurality of eigenvectors for the geometry. Based on a representative eigenvector determined from among the plurality of eigenvectors, selecting one shear matrix of a plurality of preconfigured shear matrices to use to compute a sheared box for the geometry. The sheared box is computed for the geometry using the selected shear matrix.

### BRIEF DESCRIPTION OF THE DRAWINGS

FIG. 1 illustrates a flowchart of a method for computing a sheared box for a geometry, in accordance with an embodiment.

FIG. 2 illustrates examples of sheared boxes computed for different geometry, in accordance with an embodiment.

FIG. 3 illustrates an example use of edge-aligning to compute a sheared box for a geometry, in accordance with an embodiment.

FIG. 4 illustrates an example use of normal-aligning to compute a sheared box for a geometry, in accordance with an embodiment.

FIG. 5 illustrates a flowchart of a method for selecting a predefined alignment criteria for computing a box for a geometry, in accordance with an embodiment.

FIG. 6 illustrates an example of clustering points of a geometry, in accordance with an embodiment.

FIG. 7 illustrates a flowchart of a method for rendering an image, in accordance with an embodiment.

FIG. 8 illustrates an exemplary computing system, in accordance with an embodiment.

### DETAILED DESCRIPTION

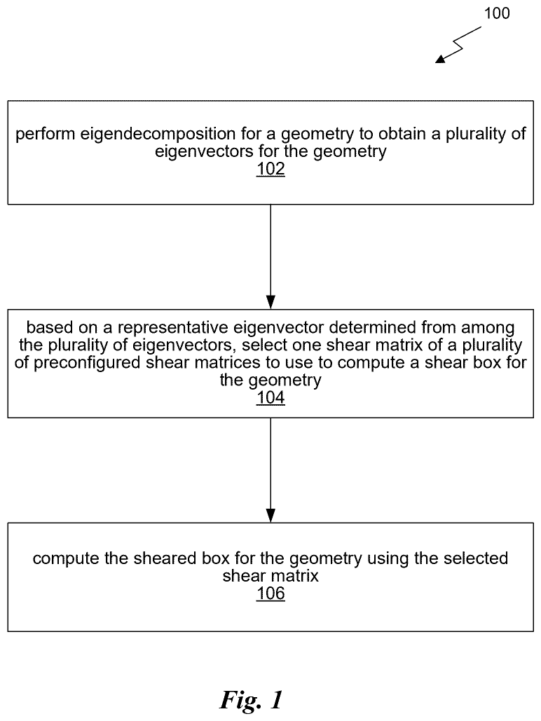

FIG. 1 illustrates a flowchart of a method 100 for computing a sheared box for a geometry, in accordance with an embodiment. The method 100 may be performed by a device, which may be comprised of a processing unit, a program, custom circuitry, or a combination thereof, in an embodiment. In another embodiment, a system comprised of a non-transitory memory storage comprising instructions, and one or more processors in communication with the memory, may execute the instructions to perform the method 100. In another embodiment, a non-transitory computer-readable media may store computer instructions which when executed by one or more processors of a device cause the device to perform the method 100.

In a particular embodiment, the method 100 may be performed in software. The software may be a shader comprised of shader code executing on a processor, such as a graphics processing unit (GPU). The software may interface a hardware memory that stores image data for rendering. As described in further embodiments below, the method 100 may be performed to facilitate ray tracing for the image data.

In operation 102, eigendecomposition is performed for a geometry to obtain a plurality of eigenvectors for the geometry. The geometry refers to an object or portion thereof depicted in image data. In an embodiment, the image data may represent a 3D scene comprised of one or more objects.

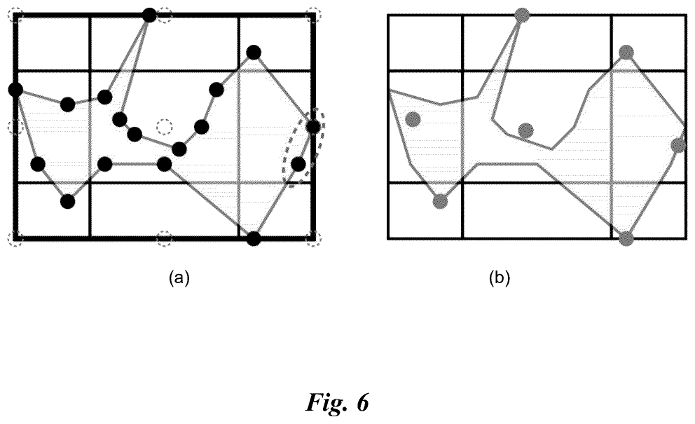

In an embodiment, the geometry may be a set of polygons, triangles, line swept sphere, or other objects. In an embodiment, the geometry may be represented with points obtained by clustering initial points on the geometry, such that the eigendecomposition is performed based on the points obtained by the clustering. In an embodiment, the clustering may include averaging subsets of the initial points on the geometry, wherein each of the subsets includes one or more initial points on the geometry that are located within a same cell of a grid overlaid on the geometry. Embodiments of the clustering process will be described in more detail below with reference to FIG. 6.

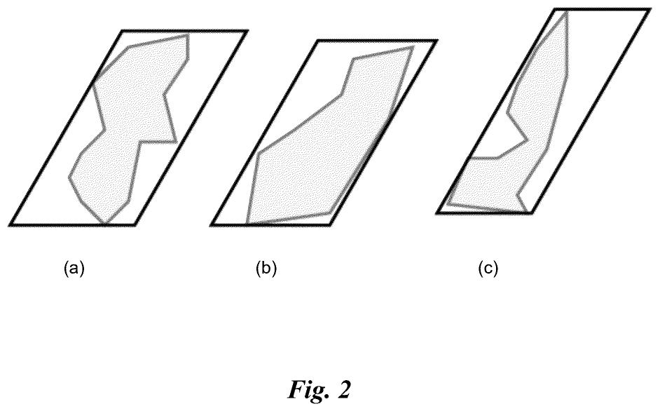

The eigendecomposition that is performed for the geometry refers to a preconfigured operation that generates a representation of the geometry comprised of a plurality of eigenvectors. In an embodiment, eigendecomposition includes first computing eigenvalues for the geometry, and then computing the plurality of eigenvectors from those eigenvalues. In an embodiment, the plurality of eigenvectors form a coordinate basis for the geometry. Embodiments of the eigendecomposition operation will be described in more detail below with reference to FIG. 2.

In operation 104, based on a representative eigenvector determined from among the plurality of eigenvectors, selecting one shear matrix of a plurality of preconfigured shear matrices to use to compute a sheared box for the geometry. In an embodiment, the preconfigured shear matrices may be supported by a GPU (e.g. that will perform ray tracing for the geometry). In an embodiment, each shear matrix of the plurality of preconfigured shear matrices may include one or more shear factors each capable of accepting a limited set of values. Examples of the plurality of preconfigured shear matrices will be described in more detail below with reference to FIG. 2.

As mentioned, the one shear matrix to use to compute the sheared box for the geometry is selected based on a representative one of the plurality of eigenvectors. The representative eigenvector refers to one of the plurality of eigenvectors which has been determined (e.g. selected, chosen, etc.) based on a predefined criteria. In an embodiment, the representative eigenvector may be determined from among the plurality of eigenvectors in accordance with a predefined alignment criteria to be used for selecting the one shear matrix of the plurality of preconfigured shear matrices.

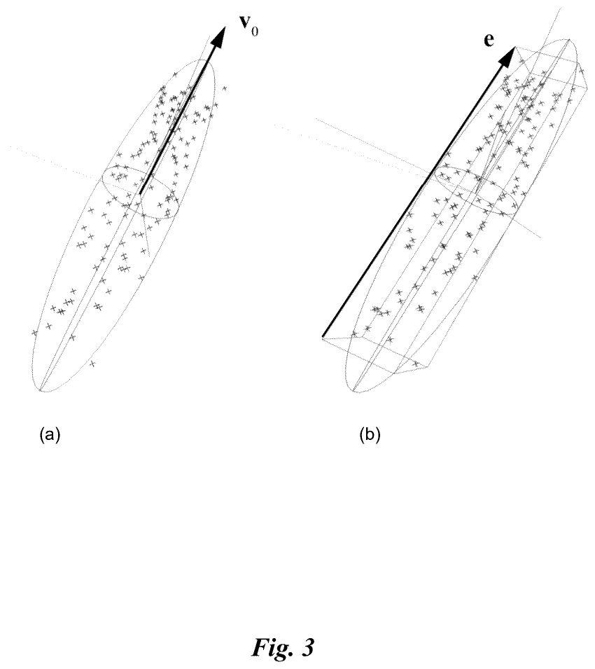

In an embodiment, the predefined alignment criteria may be edge aligning. In an embodiment, in accordance with the edge aligning, the representative eigenvector may be one of the plurality of eigenvectors corresponding to a largest eigenvalue. In an embodiment where edge aligning is used, the one shear matrix that is selected may represent a sheared box with an edge that most closely aligns with the representative eigenvector. Embodiments of using edge aligning to select a shear matrix will be described in more detail below with reference to FIG. 3.

In another embodiment, the predefined alignment criteria may be normal aligning. In an embodiment, in accordance with the normal aligning, the representative eigenvector may be one of the plurality of eigenvectors corresponding to a smallest eigenvalue. In an embodiment where normal aligning is used, the one shear matrix that is selected may represent a sheared box with a face normal that most closely aligns with the representative eigenvector.

In an embodiment, the predefined alignment criteria may be selected between edge aligning and normal aligning based on eigenvalues corresponding to the eigenvectors. For example, in an embodiment, normal aligning may be selected when a second largest one of the eigenvalues is larger than a first defined threshold or a ratio of a smallest one of the eigenvalues to the second largest one of the eigenvalues is smaller than a second defined threshold, while edge aligning may be selected when the second largest one of the eigenvalues is smaller than or equal to the first defined threshold and the ratio of the smallest one of the eigenvalues to the second largest one of the eigenvalues is larger than or equal to the second defined threshold. In another embodiment, the predefined alignment criteria may be selected between axis-aligning, edge aligning and normal aligning based on which one of the edge aligning and normal aligning results in a smallest area being covered. Axis-aligning simply means that an axis-aligned bounding box is computed.

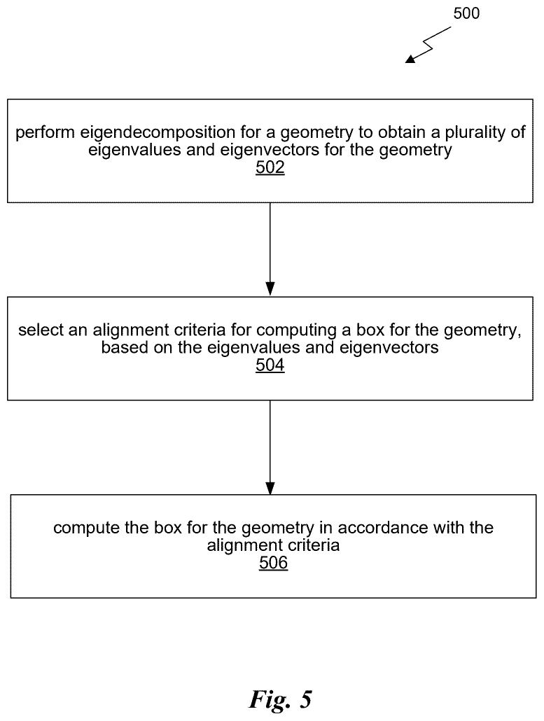

Further still, the method 100 may optionally only apply when either edge aligning or normal aligning is selected for computing the sheared box. For example, in other embodiments an axis-aligned bounding box may be used (i.e. computed for the geometry) instead of the sheared box, such as when the smallest one of the eigenvalues is greater than a third predefined threshold or when the axis-aligned bounding box covers a smaller area than the sheared box when using the edge aligning and normal aligning. Embodiments for selecting an alignment criteria for a geometry will be described in more detail below with reference to FIG. 5.

In operation 106, the sheared box is computed for the geometry using the selected shear matrix. In an embodiment, quantization may be performed on the selected shear matrix prior to computing the sheared box for the geometry. The quantization may be performed to align a value of each of the one or more shear factors with a limited set of values that the shear factor is configured to accept. In an embodiment, aligning the value of the shear factor with the limited set of values may include replacing the value of the shear factor with a closest value in the limited set of values. Embodiments for the quantization will be described in more detail below.

In an embodiment, computing the sheared box for the geometry using the selected shear matrix may include computing an inverse transpose of the selected shear matrix to determine slab normals for the sheared box, and computing a minimum and maximum projection of each of the slab normals, where the minimum and maximum projection of each of the slab normals together with the selected shear matrix represents the sheared box for the geometry.

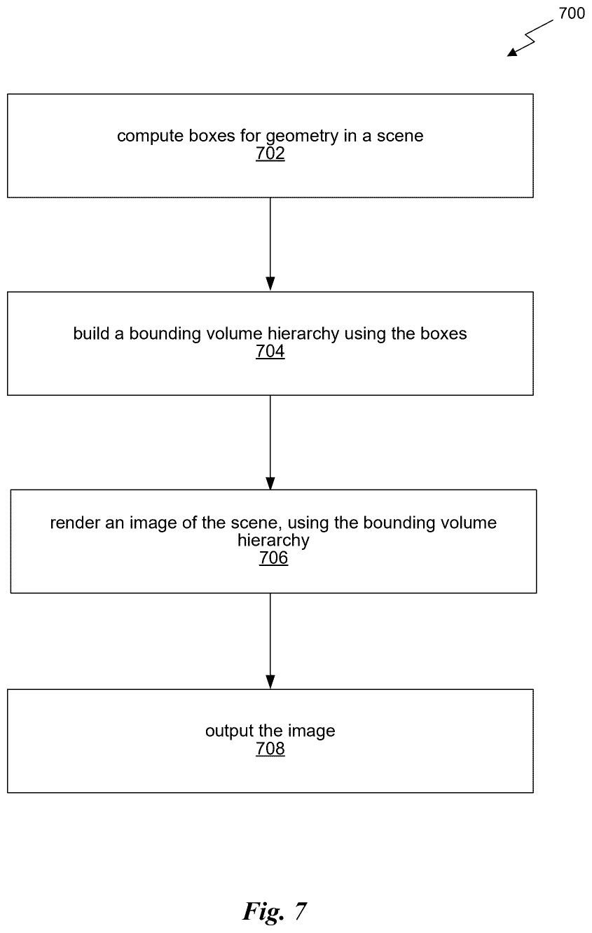

To this end, the method 100 may be performed to compute a sheared box for a geometry. The method 100, as described herein, determines which of the available shear matrices to use to compute the sheared box for the geometry as a function of the plurality of eigenvectors for the geometry, instead of requiring a brute-force approach in which every shear matrix must be tested to determine a best fit to the geometry. Further to the method 100, the sheared box may be output. In an embodiment, the sheared box may be output for use in rendering the geometry. In an embodiment, the method 100 may include using the sheared box with a bounding volume hierarchy of sheared boxes for rendering the geometry. Embodiments for rendering the geometry using a bounding volume hierarchy will be described in more detail below with reference to FIG. 7.

Further embodiments will now be provided in the description of the subsequent figures. It should be noted that the embodiments disclosed herein with reference to the method 100 of FIG. 1 may apply to and/or be used in combination with any of the embodiments of the remaining figures below.

### Statistics for Eigendecomposition

Variance and covariance can be used to do principal component analysis (PCA) using eigendecomposition. PCA is essentially fitting an oriented ellipsoid to the data representing a geometry. In addition, covariance between two variables, e.g., x and y, can be thought of as how much x is changing as y changes, which may relate to shears.

We denote variance by v=(vₓ, v_{y}, v_{z}), covariance by c=(c_{xy}, c_{xz}, c_{yz}), and the mean as m=(mₓ, m_{y}, m_{z}). The vertices or points to use for computing variance and statistics are denoted by

$${p}^{i} = {p}_{x}^{i} , {p}_{y}^{i} , {p}_{z}^{i} ,$$

where p is in a number between 0 and n-1. The points pⁱ may be the vertices of the polygons/triangles in the geometry, or a representative set of points of the geometry. The covariance matrix, which includes the variances in the diagonal and the covariances in the other elements, is symmetric and so only has 6 unique values for a 3×3 matrix, and so for the sake of efficiency, a vector of variance and a vector of covariances are used, i.e., 6 values in total, instead of the 9 values of a covariance matrix. Note that sometimes the average is also needed, which needs another three values.

Variance for the x-components is defined per Equation 1.

$${v}_{x} = \frac{1}{n} {\sum }_{i = 0}^{n - 1} {( {p}_{x}^{i} - {m}_{x} )}^{2} \qquad Equation 1$$

Covariance for and x and y, for example, can be defined per Equation 2.

$${c}_{x y} = \frac{1}{n} {\sum }_{i = 0}^{n - 1} ( {p}_{x}^{i} - {m}_{x} ) ( {p}_{y}^{i} - {m}_{y} ) \qquad Equation 2$$

Average (or mean) for x can be defined per Equation 3.

$${m}_{x} = \frac{1}{n} {\sum }_{i = 0}^{n - 1} {p}_{x}^{i} \qquad Equation 3$$

In the following embodiments described herein, the collection of m, v, and c may be referred to as statistics.

Note that first computing the average, which is a loop over all the vertices, and then computing variance and covariance with yet another loop (see equations above for average, variance, and covariance) is preferably avoided, in an embodiment. Instead, both variance and covariance can be computed in a single pass. This is expressed mathematically per Equations 4-7.

$$m = {\sum }_{i = 0}^{n - 1} {p}^{i} , s = {\sum }_{i = 0}^{n - 1} ( p * p ) , c = {\sum }_{i = 0}^{n - 1} ( {p}_{x}^{i} {p}_{y}^{i} , {p}_{x}^{i} {p}_{z}^{i} , {p}_{y}^{i} {p}_{z}^{i} ) \qquad Equation 4$$

$$v = \frac{1}{n} ( s - \frac{1}{n} m * m ) \qquad Equation 5$$

$$c := \frac{1}{n} ( c - \frac{1}{n} ( {m}_{x} {m}_{y} , {m}_{x} {m}_{z} , {m}_{y} {m}_{z} ) ) \qquad Equation 6$$

$$m := \frac{1}{n} m \qquad Equation 7$$

where p*p is elementwise multiplication, and :=is an assignment operator, so m:=m/n would mean m=m/n in C++, for example. Note that Equation 4 contains three sums and these are implemented as a single loop over all points pⁱ. Equations 5 and 6 update the variance v and the covariance c, and they need to be updated before Equation 7, which updates the average m, since they depend on m.

### Principle Component Analysis and Eigendecomposition

With variances and covariances, principal component analysis (PCA) can be computed, which provides a coordinate system for a fitted, oriented ellipsoid. This is done with eigendecomposition, namely computing eigenvalues first and then eigenvectors from those, where the eigenvectors form a desired coordinate basis.

First, a symmetric covariance matrix is created from the variances and covariances. As used herein, the covariance matrix is denoted by M_{c}. The characteristic polynomial is then set up as |λI−M_{c}|=0, where |·| is the determinant. This results in a cubic polynomial λ³+k₂λ²+k₁λ+k₀=0. The solutions to this polynomial are the eigen values and the largest (in absolute value) eigenvalue corresponds to the eigenvector which is the major direction of the ellipsoid. Finding the eigenvector for a certain eigenvalue, λ, is a matter of solving the system of equations described below, including Equation 8.

$$( {M}_{c} - λ I ) v = 0 \qquad Equation 8$$

where v is the corresponding eigenvector. One function can be used for computing the coefficients of the cubic polynomial and then a second function can be used to solve the cubic polynomial and thus get the eigenvalues. Next, a third function can be used to compute the eigenvector for a certain eigenvalue. The third function performs a simplified type of Gaussian elimination, since the equation above is homogeneous (i.e., it is equal to 0, and hence always has the trivial solution v=(0,0,0)). The eigenvectors v₀ and v₁, corresponding to the two largest eigenvalues λ₀and λ₁, are computed with the third function, while the last eigenvector is computed as the cross product between the first two eigenvectors, i.e., v₂=v₀×v₁, where v₀ and v₁ have first been normalized.

The equation above can be rewritten as M_{c}v=λI and a matrix can be created which includes all three eigenvectors as column vectors, as well as a diagonal matrix L (with L chosen based on λs) with all the eigenvalues in the diagonal. Thus, the equations for all eigenvectors/values can be summarized on matrix form as M_{c}V=VL. The covariance matrix can then be written as M_{c}=VLV^{T}, where it is exploited that V is an orthogonal matrix, i.e., V⁻¹=V^{T}, i.e. the inverse is computed using the transpose. The diagonal matrix can also be split as L=\sqrt{L}\sqrt{L}=SS, i.e., S is a scaling matrix with the square roots of the eigenvalues in the diagonal. This means that M_{c}=VSSV^{T}=VSS^{T}V^{T}=VS(VS)^{T}.

Note that, in general, S⁻¹≠S^{T}, so the expression above VS(VS)^{T}≠I. However, given a normally distributed data in a unit circle, and then applying a scaling matrix and rotation matrix, i.e., multiply with VS, then the corresponding covariance matrix will be M_{c}=VS(VS)^{T}. This means that the transform of the data is dictated by the rotation matrix V and S. Since V consists of the eigenvectors of Me and S consists of the eigenvalues of M_{c}, it is key to do an eigendecomposition of M_{c}.

### Computing the Ada Sheared Box

The following description provides an overview of the shear matrices that are supported by the Ada GPU and other certain GPUs, as well as an explanation of how the normals of the slabs can be computed from these matrices. These normals are needed when finding the extents of the sheared boxes. The following description also presents a method for quickly computing which of the Ada shear matrices to use and which shear values to use to get tight fitting sheared boxes.

### The Ada Shear Matrices

There are 12 types of shear matrices supported by the Ada GPU and other certain other GPUs. The naming scheme is based on the following matrix in Table 1.

TABLE 1
$( \begin{matrix}1 & A & B \\ C & 1 & D \\ E & F & 1\end{matrix} )$

The first set of matrices are defined in Table 2.

TABLE 2
${S}_{AB} = ( \begin{matrix}1 & {s}_{0} & {s}_{1} \\ 0 & 1 & 0 \\ 0 & 0 & 1\end{matrix} ) , {S}_{CD} = ( \begin{matrix}1 & 0 & 0 \\ {s}_{0} & 1 & {s}_{1} \\ 0 & 0 & 1\end{matrix} ) , {S}_{EF} = ( \begin{matrix}1 & 0 & 0 \\ 0 & 1 & 0 \\ {s}_{0} & {s}_{1} & 1\end{matrix} )$

The second set of matrices are defined in Table 3.

TABLE 3
${S}_{BD} = ( \begin{matrix}1 & 0 & {s}_{0} \\ 0 & 1 & {s}_{1} \\ 0 & 0 & 1\end{matrix} ) , {S}_{CE} = ( \begin{matrix}1 & 0 & 0 \\ {s}_{0} & 1 & 0 \\ {s}_{1} & 0 & 1\end{matrix} ) , {S}_{AF} = ( \begin{matrix}1 & {s}_{0} & 0 \\ 0 & 1 & 0 \\ 0 & {s}_{1} & 1\end{matrix} )$

The third set of matrices are defined in Table 4.

TABLE 4
${S}_{A} = ( \begin{matrix}1 & {s}_{0} & 0 \\ 0 & 1 & 0 \\ 0 & 0 & 1\end{matrix} ) , {S}_{B} = ( \begin{matrix}1 & 0 & {s}_{0} \\ 0 & 1 & 0 \\ 0 & 0 & 1\end{matrix} ) , {S}_{C} = ( \begin{matrix}1 & 0 & 0 \\ {s}_{0} & 1 & 0 \\ 0 & 0 & 1\end{matrix} )$ ${S}_{D} = ( \begin{matrix}1 & 0 & 0 \\ 0 & 1 & {s}_{0} \\ 0 & 0 & 1\end{matrix} ) , {S}_{E} = ( \begin{matrix}1 & 0 & 0 \\ 0 & 1 & 0 \\ {s}_{0} & 0 & 1\end{matrix} ) , {S}_{F} = ( \begin{matrix}1 & 0 & 0 \\ 0 & 1 & 0 \\ 0 & {s}_{0} & 1\end{matrix} )$

Note that the shear factors s₀ and s₁ can take on only a small set of values, as described in more detail below with respect to quantization of shear values.

### Computing Slab Normals

To compute the extents of a box consisting of a set of slabs for a shearing transform that the GPU can support, the normals of the slabs must be determined. These are found by computing the inverse transpose of the shear matrix. For example, for S_{AB}, we have normals determined per the transform shown in Table 5.

TABLE 5
${S}_{AB} = ( \begin{matrix}1 & {s}_{0} & {s}_{1} \\ 0 & 1 & 0 \\ 0 & 0 & 1\end{matrix} ) ⇒ {S}_{AB}^{- T} = ( {S}_{AB}^{- T} ) = {( {( \begin{matrix}1 & {s}_{0} & {s}_{1} \\ 0 & 1 & 0 \\ 0 & 0 & 1\end{matrix} )}^{- 1} )}^{T} = {( \begin{matrix}1 & - {s}_{0} & - {s}_{1} \\ 0 & 1 & 0 \\ 0 & 0 & 1\end{matrix} )}^{T} = ( \begin{matrix}1 & 0 & 0 \\ - {s}_{0} & 1 & 0 \\ - {s}_{1} & 0 & 1\end{matrix} ) = ( \begin{matrix}\vert & \vert & \vert \\ {n}_{AB}^{0} & {n}_{AB}^{1} & {n}_{AB}^{2} \\ \vert & \vert & \vert\end{matrix} )$

which means that once the inverse transpose has been computed, the normals of the slabs can be found in the columns of the resulting matrix, e.g.,

$${n}_{A B}^{0} = ( 1 , - {s}_{0} - {s}_{0} ) ,$$

and so on. Note that it is straightforward to compute the inverse transpose in the case of the Ada shear matrices, since the inverse of a shear is just the same matrix but with negated shear terms, and the transpose is just moving columns into rows. Alternatively, one could skip the transpose and just extract the normals from the rows instead.

For S_{AB}, the normals are

$${n}_{A B}^{0} = ( 1 , - {s}_{0} - {s}_{0} ) , {n}_{A B}^{1} = ( 0 , 1 , 0 ) , , , and {n}_{A B}^{2} = ( 0 , 0 , 1 ) ,$$

as can be seen above. This means that two of the normals are the same normals as for axis-aligned bounding boxes (AABBs), and so if an AABB already has been computed, then those extents can be used for

$${n}_{A B}^{1} and {n}_{A B}^{2} ,$$

instead of projecting all points on these two normals and finding the minimum and the maximum of the projections for each normal. In addition, projecting, for example, a point p onto

$${n}_{A B}^{0} is {n}_{A B}^{0} \cdot p = {p}_{x} - {s}_{0} {p}_{y} - {s}_{1} {p}_{z} ,$$

which can be expressed as efficiently as FMA( −s₁, p_{y}, pₓ)), where FMA is a fused-multiply-and add operation.

Given the predefined range of values available for the shear factors in the matrices for the Ada GPU, there are 1,056 different configurations. The present embodiments provide a method that determines which configuration best fits a geometry without trying each of the possible (i.e. 1,056) configurations. Each configuration consists of a selection of the shear matrix type and shear value(s).

The key insight is that eigendecomposition of the covariance matrix, also called principal component analysis (PCA), gives us a coordinate system for a fitted, oriented ellipsoid around the data used for computing the covariance matrix. While this has been used to compute oriented bounding boxes (OBBs) previously, the present embodiment uses eigenvectors to compute sheared boxes specifically.

For a geometry, variances and covariances are computed. The variances and covariances are used for eigendecomposition, namely obtaining the eigenvalues and eigenvectors. The eigenvalues and eigenvectors, representing the orientation and size of an ellipsoid, is then used to find a single shear matrix with a single set of shear factors. A minimal sheared box is then found for the geometry using the single shear matrix and the single set of shear factors. FIG. 2 illustrates exemplary sheared boxes computed for different geometries using eigendecomposition. As shown, each sheared box is tightly fitted to the respective geometry.

### Alignment Criteria for Selecting a Shear Matrix

In embodiments, one of two different alignment criteria may be used to select one of the shear matrices to use to compute the sheared box for the geometry. These different alignment criteria may include edge aligning and normal aligning, embodiments of which are described in detail below.

### Edge Aligning

For edge aligning, the eigenvector corresponding to the largest eigenvalue, i.e., the major axis of the ellipsoid, provides a direction for the sheared transform to respect in order to provide a tight-fitting sheared box. One method to do this is to look at the edges of the sheared box and select a sheared box such that one of its edges aligns as best as possible to the major axis. The ellipsoid is shown in the FIG. 3 (a) together with the major eigen vector, v₀. The goal of edge aligning is to find an Ada sheared box configuration with an edge, e, that is as similar as possible to v₀, as shown in FIG. 3 (b).

For example, for S_{BD}, we can transform an AABB from (0,0,0) to (1,1,1), by multiplying the edges, (1,0,0) and (0,0,1) by S_{BD}, and this simply “extracts” the columns of the matrix, as illustrated in Table 6.

TABLE 6
${S}_{BD} = ( \begin{matrix}1 & 0 & {s}_{0} \\ 0 & 1 & {s}_{1} \\ 0 & 0 & 1\end{matrix} ) = ( \begin{matrix}\vert & \vert & \vert \\ {e}_{BD}^{0} & {e}_{BD}^{1} & {e}_{BD}^{2} \\ \vert & \vert & \vert\end{matrix} ) , i . e . {e}_{BD}^{0} = ( \begin{matrix}1 \\ 0 \\ 0\end{matrix} ) , {e}_{BD}^{1} = ( \begin{matrix}0 \\ 1 \\ 0\end{matrix} ) , {e}_{BD}^{2} = ( \begin{matrix}{s}_{0} \\ {s}_{1} \\ 1\end{matrix} )$

This means that the edge vectors for a sheared box generated using S_{BD} are parallel to

$${e}_{BD}^{0} , {e}_{BD}^{1} , and {e}_{BD}^{2} .$$

This can be done similarly for any matrix.

In an embodiment, an eigendecomposition of the variances and covariances is performed to obtain the eigenvectors v₀, v₁, and v₂, corresponding to the sorted eigenvalues λ₀, λ₁, and λ₂, where λ₀≥λ₁≥λ₂≥0. All eigenvalues are positive or zero since the covariance matrix is a real, symmetric matrix and is positive definite. One way to create a sheared box using the shear matrices at hand would be to attempt to align one of the edges

$$( e . g . {e}_{B D}^{0} , {e}_{B D}^{1} , and {e}_{B D}^{2} for {S}_{B D} )$$

of the sheared box with the major eigenvector, v₀. To do that, a scaled variant of v₀ that is divided by the component of v₀ with the largest magnitude. This is expressed as illustrated in Table 7.

TABLE 7
$f = \frac{{v}_{0}}{t} , where t = \{ \begin{matrix}{v}_{0 , x} , & if \vert {v}_{0 , x} \vert = max ( \vert {v}_{0 , x} \vert , \vert {v}_{0 , y} \vert , \vert {v}_{0 , z} \vert ) \\ {v}_{0 , y} & if \vert {v}_{0 , y} \vert = max ( \vert {v}_{0 , x} \vert , \vert {v}_{0 , y} \vert , \vert {v}_{0 , z} \vert ) \\ {v}_{0 , z} & if \vert {v}_{0 , z} \vert = max ( \vert {v}_{0 , x} \vert , \vert {v}_{0 , y} \vert , \vert {v}_{0 , z} \vert )\end{matrix}$

As a result, a vector f will be obtained with one component being +1, while the remaining two components of f will have absolute values that are ≤1. For example, f=(0.3, −0.2, 1). This vector resembles

$${e}_{BD}^{2}$$

above, ie., one edge of a sheared box can be aligned with f if the BD shear matrix is used and s₀=fₓ=0.3 and s₁=f_{y}=−0.2 are selected, in this example.

Similarly to the above, this means that if fₓis +1, then the CE transform is used, and if f_{y} is +1, then the AF transform is used, and finally, if f_{z} is +1, the transform BD is used. Note that in another embodiment, when computing f, an index to the largest component may be returned, i.e., this index would be 0 if fₓ=1, 1 if f_{y}=+1, and else the index would be 2.

Table 8 illustrates an example in pseudocode of using edge aligning to select a shear matrix for a given geometry, where in the example f has been computed as described above and the index is called indexToMaxMagnitudeComponent.

TABLE 8

| | |
|---|---|
| 1 | if(indexToMaxMagnitudeComponent==0) // X-component of f=(f.x, f.y, f.z) is |

largest and equal to 1.

| | |
|---|---|
| 2 | { |
| 3 | // Use CE transform with s_0 = f.y and s_1 = f.z. |
| 4 | shearMtx = float3x3(1, 0, 0, |
| 5 | f.y, 1, 0, |
| 6 | f.z, 0, 1); |
| 7 | } |
| 8 | else if(indexToMaxMagnitudeComponent==1) // Y-component of f=(f.x, f.y, |

f.z) is largest and equal to 1.

| | |
|---|---|
| 9 | { |
| 10 | // Use AF transform with s_0 = f.x and s_1 = f.z. |
| 11 | shearMtx = float3x3(1, f.x, 0, |
| 12 | 0, 1, 0, |
| 13 | 0, f.z, 1); |
| 14 | } |
| 15 | else // // Z-component of f=(f.x, f.y, f.z) is largest and equal to 1. |
| 16 | { |
| 17 | // Use BD transform with s_0 = f.x and s_1 = f.y. |
| 18 | shearMtx = float3x3(1, 0, f.x, |
| 19 | 0, 1, f.y, |
| 20 | 0, 0, 1); |
| 21 | } |
| 22 | // Project the vertices onto N0, N1, and N2 to find the extents of the |
| | sheared box. |

Aligning to one edge of the sheared box is one important step towards providing a tight-fitting sheared box. As mentioned above, in an embodiment the shear factors s₀ and s₁ can take on only a small set of values, and in this case s₀ and s₁ must be quantized to the allowed values. This is described in more detail below with respect to quantization of shear values. However, prior to quantization, the A, B, C, D, E and F matrices may be used when aligning with edges, even prior to quantization.

In each of the if-cases in Table 8 above, there is a chance that the major eigenvector is sufficiently close to one of the major axes, i.e., (1,0,0), (0,1,0), (0,0,1). For example, if S_{BD} is chosen and the major axis is sufficiently close to (0,0,1), then there is no point in using S_{BD}, because the “power” of the shear matrix would be wasted by aligning with (0,0,1), which many other matrices already align with. So in the case of v₀ being sufficiently close to (0,0,1), it must be the case that shearing is best done in the xy-plane instead, i.e., S_{A} or S_{C} can be used, which both have e²=(0,0,1).

So in the example above, it must be determined whether the major eigenvector is sufficiently close to one of the major axes, and then which of S_{A} and S_{C} to select.

In the example above, f_{z}=1, and therefore, f is sufficiently close to (0,0,1) if |fₓ|<δ and |f_{y}|<δ, where δ is dictated by how quantization of shear values is done. If this is the case, then the second largest eigenvector, v₁, is used to compute the shear factor. Since it is already known that v_{0,z} must be close to ±1, then v_{1,z} must be close to 0.0. If |v_{1,x}|>|v_{1,y}|, then a shear factor s=v_{1,y}/v_{1,x} is computed and the C transform is selected, and else s=v_{1,x}/v_{1,y} and the A transform is selected. And similarly for the x and y axes. This can be combined with the above code in Table 8 as shown in Table 9.

TABLE 9

| | |
|---|---|
| 1 | if(indexToMaxMagnitudeComponent==0) // X-component of f=(f.x, f.y, f.z) is |

largest and equal to 1.

| | |
|---|---|
| 2 | { |
| 3 | if (abs(f.y) <= delta && abs(f.z) <= delta) |
| 4 | { |
| 5 | if(abs(v1.y) > abs(v1.z)) // v1 is the 2nd |
| | largest eigenvector. |
| 6 | { // F |
| 7 | shearMtx = float3x3(1, 0, 0, |
| 8 | 0, 1, 0, |
| 9 | 0, v1.z/ v1.y, 1); |
| 10 | } |
| 11 | else |
| 12 | { // D |
| 13 | shearMtx = float3x3(1, 0, 0, |
| 14 | 0, 1, v1.y / v1.z, |
| 15 | 0, 0, 1); |
| 16 | } |
| 17 | } |
| 18 | else // Use CE transform with s_0 = f.y and s_1 = f.z. |
| 19 | { |
| 20 | shearMtx = float3x3(1, 0, 0, |
| 21 | f.y, 1, 0, |
| 22 | f.z, 0, 1); |
| 23 | } |
| 24 | } |
| 25 | else if(indexToMaxMagnitudeComponent==1) // Y-component of f=(f.x, f.y, |

f.z) is largest and equal to 1.

| | |
|---|---|
| 26 | { |
| 27 | if (abs(f.x) <= delta && abs(f.z) <= delta) |
| 28 | { |
| 29 | if(abs(v1.x) > abs(v1.z)) // v1 is the 2nd |
| | largest eigenvector. |
| 30 | { // E |
| 31 | shearMtx = float3x3(1, 0, 0, |
| 32 | 0, 1, 0, |
| 33 | v1.z / v1.x, 0.0f, 1.0f); |
| 34 | } |
| 35 | else |
| 36 | { // B |
| 37 | shearMtx = float3x3(1, 0, v1.x / v1.z, |
| 38 | 0, 1, 0, |
| 39 | 0, 0, 1); |
| 40 | } |
| 41 | } |
| 42 | else // Use AF transform with s_0 = f.x and s_0 = f.z. |
| 43 | { |
| 44 | shearMtx = float3x3(1, f.x, 0, |
| 45 | 0, 1, 0, |
| 46 | 0, f.z, 1); |
| 47 | } |
| 48 | } |
| 49 | else // // Z-component of f=(f.x, f.y, f.z) is largest and equal to 1. |
| 50 | { |
| 51 | if (abs(f.x) <= delta && abs(f.y) <= delta) |
| 52 | { |
| 53 | if(abs(v1.x) > abs(v1.y)) // v1 is the 2nd |

largest eigenvector.

| | |
|---|---|
| 54 | { // C |
| 55 | shearMtx = float3x3(1, 0, 0, |
| 56 | v1.y / v1.x, 1, 0, |
| 57 | 0, 0, 1); |
| 58 | } |
| 59 | else |
| 60 | { // A |
| 61 | shearMtx = float3x3(1, v1.x / v1.y, 0, |
| 62 | 0, 1, 0, |
| 63 | 0, 0, 1); |
| 64 | } |
| 65 | } |
| 66 | else // Use BD transform with s_0 = f.x and s_1 = f.y. |
| 67 | { |
| 68 | shearMtx = float3x3(1, 0, f.x, |
| 69 | 0, 1, f.y, |
| 70 | 0, 0, 1); |
| 71 | } |
| 72 | } |
| 73 | |
| 74 | // Project the vertices onto N0, N1, and N2 to find the extents of the |
| | sheared box. |

In an embodiment, when the shear matrix has been selected, quantization is needed, which is described further below, and after that all vertices are projected onto the normals of the sheared box. These can be computed as described above with respect to Computing the slab normals.

### Normal Aligning

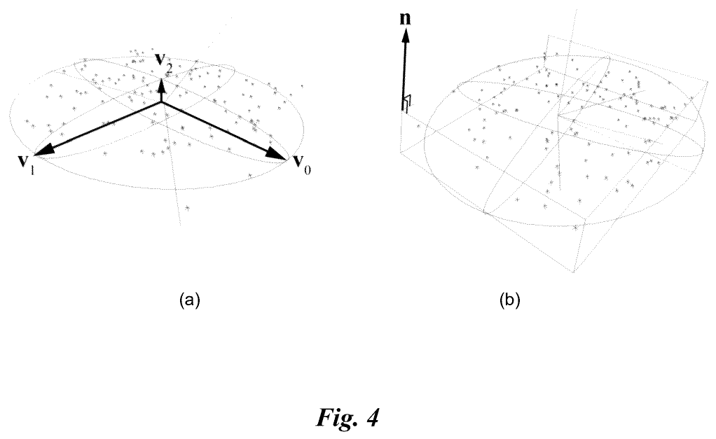

Assume that the vertices which we want to compute the sheared matrix for are distributed inside a sphere that has been compressed in one direction, denoted as n. Then the major eigenvector will be orthogonal to n and in general the major eigenvector can essentially be any vector orthogonal to n. Also, since there are no typically perfect spheres, the covariance and eigenvector computation can produce results that are rather unstable, which may tend to make for big (i.e. non-fitted) sheared boxes. Instead, a different approach may be taken where one of the normals of the sheared box configuration is aligned with n as much as possible. Since there is approximately a compressed (in one direction) sphere, this means that the smallest eigenvector, v₂, should be used as the vector to align to. This is illustrated in FIG. 4 where the two largest eigenvectors, v₀ and v₁, are approximately of the same lengths, and instead the goal is to find a sheared box configuration which has a normal, n, that aligns as well as possible with the smallest eigenvector, v₂.

Similarly to edge aligning, the smallest eigenvector, v₂, is divided with the component with the largest magnitude. This new vector is denoted as n, and it has one component being exactly 1, and the other two have magnitudes smaller or equal to 1. As before, the index to the component with the largest magnitude is computed and stored in indexToMaxMagnitudeComponent.

This normal alignment approach is illustrated in the pseudocode in Table 10 below. Recall that the slab normals are obtained from the columns of inverse transpose of the shear matrix, as described above. This means, for example, to align with a vector (1,0.2,0.1), a matrix whose inverse transpose has a column that resembles (1,0.2,0.1) must be found. The first column of the inverse transpose of S_{AB} is (1,−s₀,−S₁), which fits the example vector here. Therefore, S_{AB} can be used and s₀=−n_{y} and s₁=−n_{z} can be set.

TABLE 10

| 1 | if (indexToMaxMagnitudeComponent == 0) // float3 n = |
|---|---|
| (n.x, n.y, n.z) is the normal vector described in the text above. | |
| 2 | { |
| 3 | // AB |
| 4 | shearMtx = float3x3(1, −n.y, −n.z, |
| 5 | 0, 1, 0, |
| 6 | 0, 0, 1); |
| 7 | } |
| 8 | else if (indexToMaxMagnitudeComponent == 1) |
| 9 | { |
| 10 | // CD |
| 11 | shearMtx = float3x3(1, 0, 0, |
| 12 | −n.x, 1, −n.z, |
| 13 | 0, 0, 1); |
| 14 | } |
| 15 | else // indexToMaxMagnitudeComponent == 2 |
| 16 | { |
| 17 | // EF |
| 18 | shearMtx = float3x3(1, 0, 0, |
| 19 | 0, 1, 0, |
| 20 | −n.x, −n.y, 1); |
| 21 | } |

### Quantization of the Shear Values

Quantization is straightforward for AF, BD, and CE. In an embodiment, there are 17 s₀ and s₁ values to choose from,

$$\pm ( \frac{1}{8} , \frac{2}{8} , \frac{3}{8} , \frac{4}{8} , \frac{5}{8} , \frac{6}{8} , \frac{7}{8} , 1 ) ,$$

and they are uniformly distributed. Therefore, it is a simple matter of just “rounding” to the closest valid value. For AB, CD, and EF, the valid values are

$$\pm [ \frac{1}{8} , \frac{1}{4} , \frac{1}{2} , 1 ] .$$

To select the value that is closest to the computed shear value, a process may be performed per the pseudocode in Table 11.

TABLE 11

| float quantizeAB_CD_EF(float shear) | |
|---|---|
| { | |
| float absShear = std::abs(shear); | |
| if (absShear > 0.75f) | // 3/4 = 0.75 |
| return std::copysignf(1.0f, shear); | |
| else if (absShear > 0.375f) | // 3/8 = 0.375 |
| return std::copysignf(0.5f, shear); | |
| else if (absShear > 0.1875f) | // 3/16 = 0.1875 |
| return std::copysignf(0.25f, shear); | |
| else if (absShear > 0.0625f) | // 1/16 = 0.0625 |

```
    return std::copysignf(0.125f, shear);
  else
    return 0.0f;
}
```

For all the shear matrices with two shear values, i.e., matrices of the types AF, BD, CE, AB, CD, and EF, setting one shear value to 0 means that the shear matrix type becomes one of A, B, C, D, E, or F, so an embodiment will check if this occurs and then just switch matrix type and possibly change quantization, since these modes have the same type of quantization as AF, BD, and CE.

### Computing the Sheared Box

From a representative (selected) shear matrix S, the shear box can be computed. In an example, a set of N points is used. The set of points can be from a triangle geometry or any primitive that can be projected onto a normal. The goal is to find the smallest sheared box that contains the N points given S, which can be achieved by: (1) given S, find the three normals of S; (2) denote the normals by n0, n1, n2 (see “Computing slab normals” described above); (3) and find the minimum and maximum projection of the points for n0, n1, and n2, which gives 6 values (a min and a max for n0, a min and a max for n1, and a min and a max for n2) that together with S describes the smallest sheared box around the N points. To find the minimum and maximum projections, all of the N points may be looped over, with the dot product between n0, n1, n2 and each of the points computed, and with keeping the min and max for each normal.

Table 12 gives an example of the above described process for computing a sheared box.

TABLE 12
//Assume the normals have been retrieved using the method in “Computing slab normals” and
call them n0, n1, n2 as before. Then for each normal, compute dmin, and dmax, which are the
minimum and maximum projections. Let's denote them by d0min, d0max, d1min, d1max,
d2min, and d2max.

| | |
|---|---|
| d0min = maxfloat | // Init to large value |
| d0max =−maxfloat | // Init to small value |

d1min = maxfloat
d1max =−maxfloat
d2min = maxfloat
d2max =−maxfloat
for (i = 0; i < N; i++)
{

| | |
|---|---|
| proj0 = dot(points[i], n0); | // dot = dot product = projection of points[i] onto n0 |

```
  proj1 = dot(points[i], n1);
  proj2 = dot(points[i], n2);
```

| | |
|---|---|
| d0min = min(d0min, proj0); | // find minimum value |
| d0max = max(d0max, proj0); | // find maximum value |

```
    d1min = min(d1min, proj1);
    d1max = max(d1max, proj1);
  d2min = min(d2min, proj2);
  d2max = max(d2max, proj2);
}
```

//At this point in the code, d0min, d0max, d1min, d1max, d2min, and d2max describes the extents of the sheared box for the N points and using the selected shear matrix S, from which the normals, n0, n1, n2 were computed.

FIG. 5 illustrates a method 500 for selecting a predefined alignment criteria for computing a box for a geometry, in accordance with an embodiment. The method 500 may be carried out in the context of the embodiments described above. In particular, the method 500 may select between using edge aligning, normal aligning, and axis-aligning for computing a box for a geometry, in accordance with an embodiment.

In operation 502, eigendecomposition is performed for a geometry to obtain a plurality of eigenvalues and eigenvectors for the geometry. In operation 504, an alignment criteria is selected for computing a box for the geometry, based on the eigenvalues and eigenvectors. As noted above, the alignment criteria may be selected from among edge aligning, normal aligning, and axis-aligning.

### Alignment Criteria Selection—Method 1

In an embodiment, only one of edge or normal aligning is evaluated (not both). In this embodiment, eigenvalues control which method to use. In particular, a vector s=(1, \sqrt{λ₁}/\sqrt{λ₀},/\sqrt{λ₂}/\sqrt{λ₀}), where λ₀≥λ₁≥λ₂≥0.

If s_{z} is relatively large, then this indicates a spherical shape, and an axis-aligning is selected. If, however, s_{y} is relatively large, and s_{z}/s_{y} is relatively small, then this indicates a “compressed” sphere and the normal aligning is selected. Otherwise, edge aligning is selected. This is summarized in the pseudocode in Table 12 below.

```
TABLE 12
const float AABB_threshold = 0.45f;
const float y_threshold = 0.7f;
const float zy_threshold = 0.2f;
if (s.z > AABB_threshold)
{
  shearMtx = float3x3::identity( );
}
else if (s.y > y_threshold ∥ s.z / s.y < zy_threshold)
{
  computeShearMatrixAlignedToNormal(eigenVec0, eigenVec1, eigenVec2, eigenVals,
shearMtx);
}
else
{
  computeShearMatrixAlignedToSide(eigenVec0, eigenVec1, eigenVec2, eigenVals,
shearMtx);
}
quantizeShearMatrix(shearMtx, shearMode);
// Next, update sheared boxes using shearMtx.
```

In an embodiment, the thresholds can be optimized by searching for the best setup of parameters for real data.

### Alignment Criteria Selection—Method 2

In another embodiment, the eigendecomposition is computed for the geometry and then one shear matrix is determined using edge aligning and one shear matrix is determined using normal aligning. The area of an axis-aligned bounding box, the area for the sheared box computing using edge aligning, and the area for the sheared box computed using normal aligning are determined, and the alignment criteria resulting in the smallest area is selected.

Once the alignment criteria is selected, then in operation 506 the box for the geometry is computed in accordance with the alignment criteria. In the case of Method 2 described above, the box for the geometry may be computed as a part of operation 504. When the axis-aligning is selected, then an AABB is computed for the geometry. When the edge aligning or normal aligning is selected, then a sheared box is computed for the geometry.

FIG. 6 illustrates an example of clustering points of a geometry, in accordance with an embodiment. As described above with reference to the method of FIG. 1, points on the geometry may be clustered prior to performing eigendecomposition.

Computing the variances and the covariances for a large set of triangles (or other data) can give misleading results. In an embodiment, a set of points may be found which are located approximately uniformly over an input mesh of the geometry. As illustrated in FIG. 6 (a), a 2D mesh for a geometry includes vertices as solid circles. The outer AABB is shown as well, with 3×3, dashed circles, which are selected as initial cluster locations. These cluster locations are just a grid evenly spread out over the AABB, from the minimum corner to the maximum. Around each cluster location, there is a rectangle which is half the size of the AABB box in x and y. Each such rectangle is visualized as clipped to the AABB.

The cluster step is shown in FIG. 6 (b), where the cluster points (now shown as solid circles) are the average of all the vertices in (a) to the left inside its respective rectangle. Note that a cluster point is removed if it does not have any vertices inside its rectangle. The rectangle to the right of the middle of (a) has two points (shown with a dashed ellipse) and in (b) its updated cluster point (solid circle) has been computed as the average of the two points from (a). Similar operations are done for the rest of the cluster points as well.

Note that the assignment of each point to a cluster is done simultaneously as that cluster's average point is updated with an incremental average computation, only one pass is performed over the points.

In 3D, 3×3×3 initial cluster points is placed on the 3D AABB, from the minimum corner to the maximum corner. In some embodiments, the reduction may be from 128 vertices down to a maximum 3×3×3=27 cluster points. Variances and covariances can then be computed using these cluster points.

FIG. 7 illustrates a flowchart of a method 700 for rendering an image, in accordance with an embodiment. In operation 702, boxes for geometry in a scene are computed. The boxes may include sheared boxes, in an embodiment. The sheared boxes may be computed per the method 100 of FIG. 1.

In operation 704, a bounding volume hierarchy is built using the boxes. The bounding volume hierarchy is a tree-like structure that is configured to be used to accelerate ray tracing for the scene. The bounding volume hierarchy organizes geometries in the scene into a hierarchy of bounding volumes (e.g. sheared boxes), allowing for efficient intersection testing by quickly eliminating objects that don't intersect a given query.

In operation 706, an image of the scene is rendered, using the bounding volume hierarchy. As noted above, the bounding volume hierarchy is used to perform ray tracing for the scene. The ray tracing may be performed to compute pixel information for the image, such as the color and illumination of each pixel in the image. The image may then be rendered in accordance with the pixel information.

In operation 708, the image is output. In an embodiment, the image may be output to a memory. In an embodiment, the image may be output to a display device. In an embodiment, the image may be output to a downstream application for further processing, such as a virtual reality or augmented reality application that uses the image to create a virtual reality or augmented reality experience for a user.

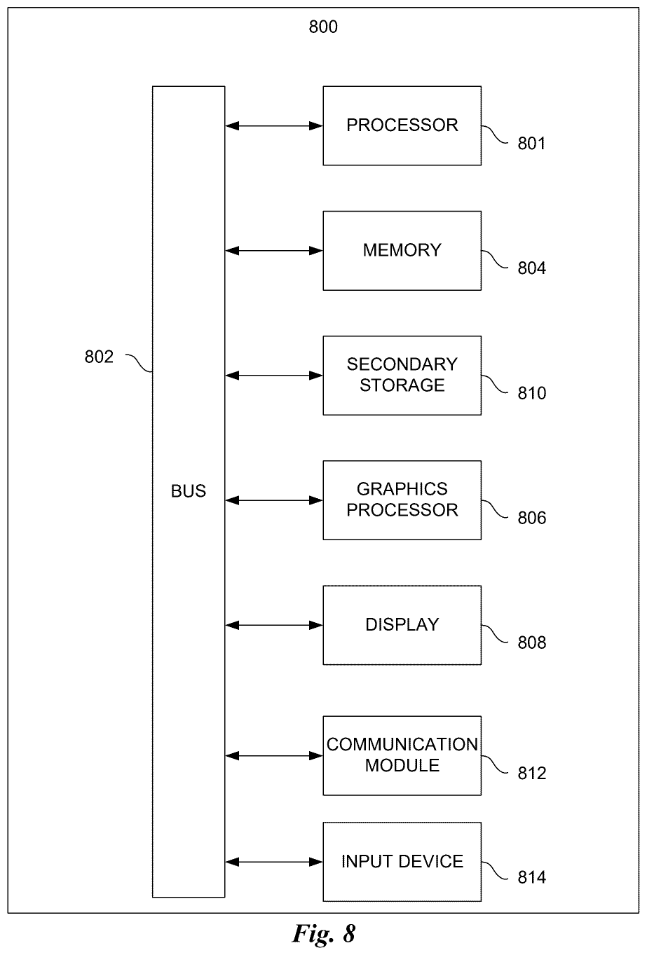

FIG. 8 illustrates an exemplary computing system 800, in accordance with an embodiment. The exemplary computing system 800 may be implemented to carry out any of the methods described herein. For example, the exemplary computing system 800 may perform the bounding box computations described above, and in some embodiments may also perform the image rendering as described above.

As shown, the system 800 includes at least one central processor 801 which is connected to a communication bus 802. The system 800 also includes main memory 804 [e.g. random access memory (RAM), etc.]. The system 800 also includes a graphics processor 806. In some embodiments, the system 800 includes a display 808.

The system 800 may also include a secondary storage 810. The secondary storage 810 includes, for example, a hard disk drive and/or a removable storage drive, representing a floppy disk drive, a magnetic tape drive, a compact disk drive, a flash drive or other flash storage, etc. The removable storage drive reads from and/or writes to a removable storage unit in a well-known manner.

Computer programs, or computer control logic algorithms, may be stored in the main memory 804, the secondary storage 810, and/or any other memory, for that matter. Such computer programs, when executed, enable the system 800 to perform various functions, including for example performing image data decompression. Memory 804, storage 810 and/or any other storage are possible examples of non-transitory computer-readable media.

The system 800 may also include one or more communication modules 812. The communication module 812 may be operable to facilitate communication between the system 800 and one or more networks, and/or with one or more devices (e.g. game consoles, personal computers, servers etc.) through a variety of possible standard or proprietary wired or wireless communication protocols (e.g. via Bluetooth, Near Field Communication (NFC), Cellular communication, etc.).

As also shown, in some embodiments the system 800 may include one or more input devices 814. The input devices 814 may be a wired or wireless input device. In various embodiments, each input device 814 may include a keyboard, touch pad, touch screen, game controller, remote controller, or any other device capable of being used by a user to provide input to the system 800.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method, comprising:
at a device:
performing eigendecomposition for a geometry of a scene to obtain a plurality of eigenvectors for the geometry;
based on a representative eigenvector determined from among the plurality of eigenvectors, selecting one shear matrix of a plurality of preconfigured shear matrices to use to compute a sheared box for the geometry;
computing the sheared box for the geometry using the selected shear matrix; and
using the sheared box with a bounding volume hierarchy to render the geometry in an image.

2. The method of claim 1, wherein the plurality of preconfigured shear matrices are supported by a graphics processing unit (GPU) that renders the geometry in the image.

3. A method, comprising:
at a device:
performing eigendecomposition for a geometry to obtain a plurality of eigenvectors for the geometry;
based on a representative eigenvector determined from among the plurality of eigenvectors, selecting one shear matrix of a plurality of preconfigured shear matrices to use to compute a sheared box for the geometry;
computing the sheared box for the geometry using the selected shear matrix.

4. The method of claim 3, wherein the representative eigenvector is determined from among the plurality of eigenvectors in accordance with a predefined alignment criteria to be used for selecting the one shear matrix of the plurality of preconfigured shear matrices.

5. The method of claim 4, wherein the predefined alignment criteria is edge aligning.

6. The method of claim 5, wherein in accordance with the edge aligning, the representative eigenvector is one of the plurality of eigenvectors corresponding to a largest eigenvalue.

7. The method of claim 6, wherein the one shear matrix that is selected represents a sheared box with an edge that most closely aligns with the representative eigenvector.

8. The method of claim 4, wherein the predefined alignment criteria is normal aligning.

9. The method of claim 8, wherein in accordance with the normal aligning, the representative eigenvector is one of the plurality of eigenvectors corresponding to a smallest eigenvalue.

10. The method of claim 9, wherein the one shear matrix that is selected represents a sheared box with a face normal that most closely aligns with the representative eigenvector.

11. The method of claim 4, wherein the predefined alignment criteria is selected between axis-aligning, edge aligning and normal aligning based on eigenvalues corresponding to the eigenvectors.

12. The method of claim 11, wherein:
(a) normal aligning is selected when:
a second largest one of the eigenvalues is larger than a first defined threshold or a ratio of a smallest one of the eigenvalues to the second largest one of the eigenvalues is smaller than a second defined threshold; and
(b) edge aligning is selected when:
the second largest one of the eigenvalues is smaller than or equal to the first defined threshold and the ratio of the smallest one of the eigenvalues to the second largest one of the eigenvalues is larger than or equal to the second defined threshold.

13. The method of claim 11, wherein an axis-aligned bounding box is used instead of the sheared box when the smallest one of the eigenvalues is greater than a third predefined threshold.

14. The method of claim 4, wherein the predefined alignment criteria is selected between edge aligning and normal aligning based on which one of the edge aligning and normal aligning results in a smallest area being covered.

15. The method of claim 14, wherein an axis-aligned bounding box is used instead of the sheared box when the axis-aligned bounding box covers a smaller area than the sheared box when using the edge aligning and normal aligning.

16. The method of claim 3, wherein the plurality of preconfigured shear matrices are supported by a graphics processing unit (GPU).

17. The method of claim 3, wherein each shear matrix of the plurality of preconfigured shear matrices includes one or more shear factors each capable of accepting a limited set of values.

18. The method of claim 3, wherein quantization is performed on the selected shear matrix prior to computing the sheared box for the geometry to align a value of each of the one or more shear factors with a limited set of values that the shear factor is configured to accept.

19. The method of claim 18, wherein aligning the value of the shear factor with the limited set of values includes replacing the value of the shear factor with a closest value in the limited set of values.

20. The method of claim 3, wherein the geometry is represented with points obtained by clustering initial points on the geometry, such that the eigendecomposition is performed based on the points obtained by the clustering.

21. The method of claim 20, wherein the clustering includes averaging subsets of the initial points on the geometry, wherein each of the subsets includes one or more initial points on the geometry that are located within a same cell of a grid overlaid on the geometry.

22. The method of claim 3, wherein computing the sheared box for the geometry using the selected shear matrix includes:
computing an inverse transpose of the selected shear matrix to determine slab normals for the sheared box, and
computing a minimum and maximum projection of each of the slab normals,
wherein the minimum and maximum projection of each of the slab normals together with the selected shear matrix represents the sheared box for the geometry.

23. The method of claim 3, further comprising, at the device:
using the sheared box with a bounding volume hierarchy of sheared boxes for rendering the geometry.

24. A system, comprising:
a processor executing code to:
perform eigendecomposition for a geometry to obtain a plurality of eigenvectors for the geometry;
based on a representative eigenvector determined from among the plurality of eigenvectors, select one shear matrix of a plurality of preconfigured shear matrices to use to compute a sheared box for the geometry; and
compute the sheared box for the geometry using the selected shear matrix.

25. A non-transitory computer-readable media storing computer instructions which when executed by one or more processors of a device cause the device to:
perform eigendecomposition for a geometry to obtain a plurality of eigenvectors for the geometry;
based on a representative eigenvector determined from among the plurality of eigenvectors, select one shear matrix of a plurality of preconfigured shear matrices to use to compute a sheared box for the geometry; and
compute the sheared box for the geometry using the selected shear matrix.
